(19) United States
(12) Patent Application Publication
(10) Pub. No.: US 2018/0276694 A1
(43) Pub. Date: Sep. 27, 2018

(54) CONSUMER RESPONSE INTELLIGENT SPEND PREDICTION SYSTEM

(71) Applicant: Loyalty Vision Corporation, Spokane, WA (US)

(72) Inventors: Stephen Ross, Spokane, WA (US); Vance Hilderman, Los Angeles, CA (US); Ryan Carr, Apex, NC (US); Tom Browne, Chicago, IL (US)

(21) Appl. No.: 15/933,344

(22) Filed: Mar. 22, 2018

Related U.S. Application Data
(60) Provisional application No. 62/475,061, filed on Mar. 22, 2017.

(51) Int. Cl. G06Q 30/02; G06N 5/04; G06N 99/00

(52) U.S. Cl. CPC G06Q 30/0202; G06N 99/005; G06N 5/04

(57) ABSTRACT

A system, computer program, and database for the accurate determination of consumer spend at the individual household level by category using a combination of census spend data at the neighborhood (Consumer Block Group) level and demographic data. The invention defines a set of detailed measures of consumer spend and computes values for those measures using unique combinations of data and machine learning generating a CBG spend model and a household spend model to iteratively refine the spend models and derive therefrom individual household dollar spend amounts to accurately identify target households or groups of households most likely to respond to advertisements or consumer communications.

### RELATED APPLICATIONS

This application claims priority from U.S. Provisional Application No. 62/475,061, filed on Mar. 22, 2017 and entitled “Total Expenditures Models,” the entire contents of which are hereby incorporated herein.

### BACKGROUND OF THE INVENTION

### Field of Invention

The present invention relates to a targeted marketing system for predicting household spend of particular households based on spend models generated from segmented demographic data, actual spend data and iterative machine learning to accurately predict household spend.

### Background

The marketing of goods and services has increasingly relied on methods of targeting communications to specific households. Targeted marketing uses various methods to try to identify market segments (groups of households) most likely to buy the products and services being offered and promoted by advertisers which is in contrast to mass marketing (e.g., billboard junk mail and the like) done without regard to the specific characteristics of a targeted market segment.

Targeted marketing looks for correlations between the characteristics of a market segment, by and the interest of that segment in a product or service. This correlation information enables an advertiser to focus their advertising efforts and budget on the market segment deemed to be most likely to respond. Targeted marketing is usually much more effective than mass marketing, which tends not to consider the qualities of the consumer who views an advertisement or their likeliness to spend on that particular product or service.

In the past, targeted marketing might start by identifying primary market segments and then collecting data about those market segments that might correlated individually or as a group with the purchase of that product or service by people in the market segment. Based on the collected data, individuals deemed less likely to respond to a marketing effort are eliminated with the marketing communications focused just to those who are deemed more likely to respond. The responses from the target segment and the marketing content are monitored to determine the success of the marketing campaign with the content and target segments being altered in various ways to improve future responses. Targeted marketing falls into different types including, for example, scientific marketing, analytic marketing, closed loop marketing, and loyalty marketing.

Scientific marketing uses data mining to gather information such as where the target consumers live, how much they earn, how much time they spend online, what websites they visit, what they purchase online and the like. Marketing campaigns are then tailored to focus on the specific consumer group that is statistically more likely to be interested in the product or service being offered to increase the return on the advertising investment.

Analytical marketing provides information that businesses in multiple industries can leverage to their advantage. Data from surveys, focus groups, questionnaires, opinion polls and customer tracking are examples of the methods for obtaining information used in analytic marketing. Most companies who offer email lists, newsletters, or customer loyalty programs collect information about their consumers to build large databases. They use these databases to create sortable lists that inform their business decisions going forward. Analytical strategists need to decide what they want to know from customers, manage and organize the data, and create customer profiles to gain insight. Companies can then predict consumers' behavior from their data.

Closed loop marketing continuously collects and analyzes customer preferences from multiple channels to create targeted content for groups of customers and adjusts the marketing strategy to optimize responses. For example, a customer's preferences and search history are logged in a database each time a customer interacts with website. The marketing strategy for that customer can then be continuously adjusted based on that collected data. This two-way marketing increases the relevant information obtained allowing continuous modification of the marketing approach for each individual customer.

Loyalty marketing refers to building trust among recurrent customers and rewarding them for repeat business. Examples might include redeeming proofs-of-purchase for special products or customer loyalty reward points. Loyalty marketing concentrates on strengthening the existing customer relationships. Technology systems have been developed using customer loyalty information. For example, Patent Publication US 2004/0088221 describes a system, computer program, and database for the accurate determination of customer loyalty using a combination of shopping history data, household personal data, and demographic data to establish loyalty scores that incorporate information comparing the loyalty of a customer to a specific store with estimates of what the customer purchases in all stores selling the same types of goods. However, most loyalty reward programs focus on what a household spends for products or service obtained at a specific location such as a restaurant or store location and do not, for example, account for what the household is spending at similar locations. This decreases the ability of such systems to efficiently target advertisements. Therefore, a need remains for a system that will increase the accuracy of selecting households to whom advertising, and marketing campaigns would be targeted and thereby increase the cost efficiency and effectiveness of the campaign.

Consumer Response Intelligent Spend Prediction system (CRISP) described hereafter informs advertisers, what each household in the US is spending across all product or service provider locations. Based on the demographics of households, the CRISP system iteratively creates spend predictions of what a consumer will spend on products or services.

### SUMMARY OF THE INVENTION

The present Consumer Response Intelligent Spend Prediction (CRISP) system establishes and continuously refines and updates a model of household spending characteristics and spend predictions for each household based on three primary subsystems:

a. Geographic and demographic spending data collection subsystem. This subsystem uses geographic and demographic spend data covering over one thousand categories of spend for USA consumers (e.g., Airline Spend, Auto Insurance Spend, Soft Drink Spend) from available sources and then processes and refines that data to create data specific to individual households with full categorization of spending and spending attributes.

b. Consumer block group spend model subsystem. This subsystem uses artificial intelligence (machine learning) to self-refine household spending prediction models based on comparing and allocating actual spend data at the neighborhood level down to the individual household level by utilizing demographic data for each home in a geographical area or subgroups in the geographical area. This subsystem then incorporates machine learning to continually refine its projections thereby increasing accuracy of the projection model and dollar spend on specific goods or services derived from the model.

c. Household spend model subsystem. This subsystem receives, processes, models, refines, and then continuously re-models and refine billions of data records to produce estimated total expenditure by selected class of trade (e.g., grocery, drug-store, home improvement . . . ) for each household. The models are selected based on geographic location and household demographic characteristics. This subsystem determines then refines the consumer spending data to define detailed household dollar spend amount by individual households, across all individual households in the geographic area or a subset of geographic areas within the larger geographic area. Using these three subsystems, the CRISP system delivers detailed household spending characteristics with continuously self-improving accuracy.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a pictorial block diagram showing the overall structure of the CRISP system.

FIG. 2 is a block diagram generally illustrating the demographic data spend model generator shown in FIG. 1.

FIG. 3 is a block diagram generally illustrating the household (HH) spend model generator shown in FIG. 1.

### DETAILED DESCRIPTION

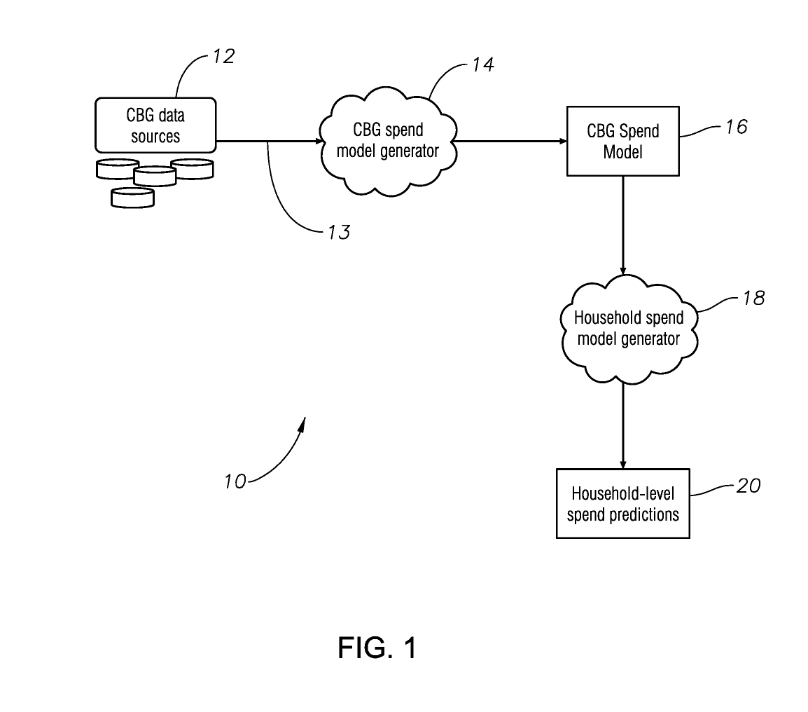

Referring to FIG. 1, a CRISP system 10 first obtains household characteristics data (consumer block group or CBG data) 13 from CBG data sources 12. This CBG data 13 could include demographic, economic, household spend and other relevant data which could potentially correlate with consumer spend on specific products or services. The CBG data 13 is received or otherwise gathered from a variety of available data sources 12 to be described hereafter. The CBG data 13 is processed in a CBG data spend model generator 14 which discretizes, bins, and segments the data and then uses machine learning to determine correlations between the different CBG data using one or more available artificial intelligence algorithms such as neural network algorithms, random forest algorithms or clustering algorithms. The result is a block group (CBG) spend model (predictor) 16. The block group spend model 16 is then provided to a household spend model generator 18 which, in connection with the CBG spend model generator 14, provides and then iteratively refines household level, spend predictions 20 that can be used to target households determined to be most likely to respond to advertisements for specific products or services.

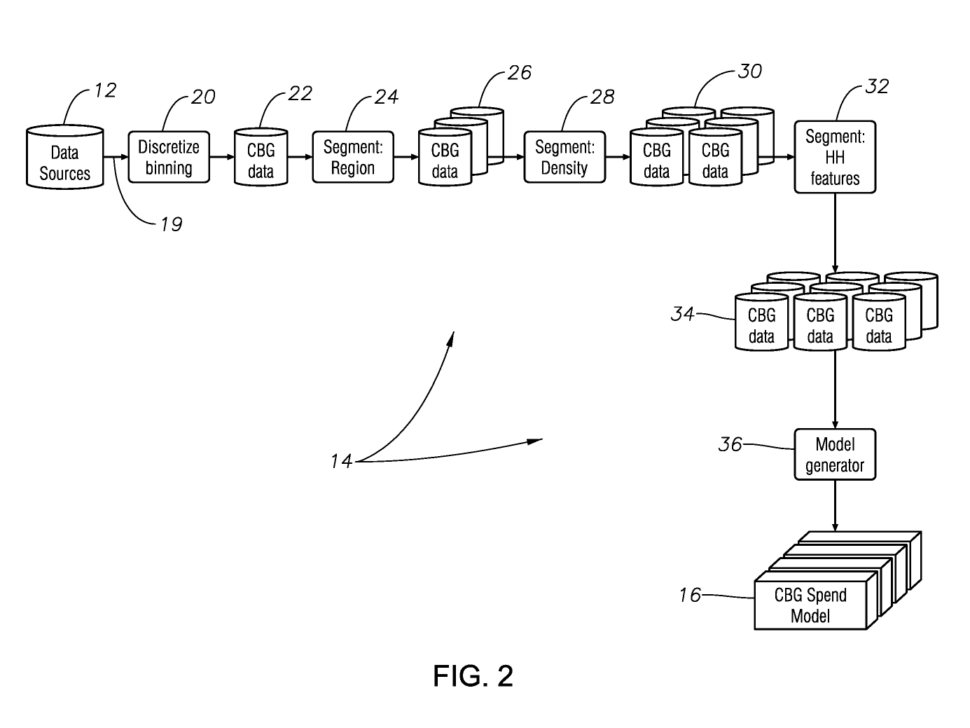

The demographic data spend model is describe in connection with FIG. 2. Household characteristic information is first obtained from sources 12 such the Bureau of Labor Statistics, the US Census, or third-party vendors such as Nielsen, ESRI & Environ Analytics. The household characteristics includes a broad range of geographic, demographic, and actual household spend information for numerous categories of products and services. The information from these sources is first processed into smaller consumer block groups based on common consumer characteristics. For example, to capture non-linear relationships between household spend and demographics and to reduce the effects of outlier values (predicted values that are too high or too low in nature), the values of specific information fields are discretized, that is replaced with by their corresponding ‘decile’ numeric ranking from 1-10. For example, using actual median home values that can range from, for example, $20,000 to over $5,000,000 makes it difficult to build a meaningful CBG spend model so these values are discretized in block 20 by replacing the actual values with a ranking or bin value of one through ten. A decile value of ‘1’ would then be assigned to median home values in the Top 10% of the nation's medium home value while a decile value of 10 would be assigned a medium home value in the bottom 10% of the nation's home values.

After the selected information categories have been, where appropriate, discretized and binned in block 20, the information is further segmented to define CBG information 22. The CBG information is further segmented in block 24, 28 and 32. In a nation as big and diverse at the United States, one prediction model could not be accurate or suitable for the entire country. Greater granularity is required. Therefore, according to one embodiment, block groups of the information 22 are segmented by common segment characteristic such as geographic region (e.g., Northwest, Southeast, counties, cities, etc.) as shown in block 24, population density (number of households per square mile, individuals per region, etc.) as shown in block 28, and household characteristic as shown in block 32. Thus, in block 24 the CBG information is segmented into nine state regions and in block 28 the CBG information is further segmented into four population per square mile population segments—urban, metro, suburb, rural. The result from block 28 is therefore nine region segments and four densities segments result in a total of 36 CBG segments illustrated by block 30. A further segmentation step in block 32 can be made based on one or more selected household characteristics. For example, if a model is to be generated for a soft drink spend category, a household characteristic such as number of children might be deemed relevant to that that spend category. Further segmenting by household characteristic would warrant segmenting into, for example, three groups based on the number of children. The result would then be nine region segments, four density segments and three number-of-children household, segments for a total of 108 segments as illustrated by block 34.

With the information being discretized, binned and segmented into multiple CBG subgroups, the present disclosure generates predictions, that is, models, of the spend for specific products or services at the household level using machine learning algorithms in model generator block 36 based on correlations with specific demographic characteristics or parameters within each CBG subgroup 34 such as age, income, and number of people in the household and the like. Machine modeling algorithms in the model generator block 36 determine correlations between the different the characteristics data in each CBG segment 34 using one or more of the available artificial intelligence algorithms such as neural network algorithms, random forest algorithms or clustering algorithms to generate a spend prediction or model for each CBG subgroup 34. Each algorithm is continuously tuned to optimize its household spend predictions—model, by continuous updating and adjustment of parameter values in the algorithm thereby achieve effective and efficient spend predictions. For example, one CBG spend model might predict that grocery spend increased in families that had a large number of teenage boys and another might predict that spending prescription drug increased as the age of the head of household increased. It should be noted that the CBG spend model will be a model that requires the input of data for one or more parameters to obtain a dollar spend value.

The process of segmentation as above described allows the model generator block 34 builds spend prediction models for each CBG subgroup based on focused consumer characteristic profiles. To illustrate, the data may show that each household in a neighborhood (i.e., consumer block group) with 317 homes in Eugene, Oreg. near an airport spends exactly $13,243 per year on bottled water. Examples of demographics of this Eugene, Oregon neighborhood might include the number of households, the location and within each household, the median age, the number of children, and the number of two-year-old Asian toddlers. Examples of spend data categories might include the total annual spend on pharmacy and the total annual spend on auto insurance.

The CBG spend model generator 14 can generate predicted spend models in over 1,000 discrete spend characteristic categories. For example, the spend prediction model(s) for one of the CBG subgroups may set $5,746 for annual grocery spend and $1,722 for annual auto insurance spend for the Joseph Smith family home located on 101 main street in Seattle Wash. This information is then used in a model into which parameters are used to compute a dollar spend number that is a prediction of the actual potential spend for each household in the United States.

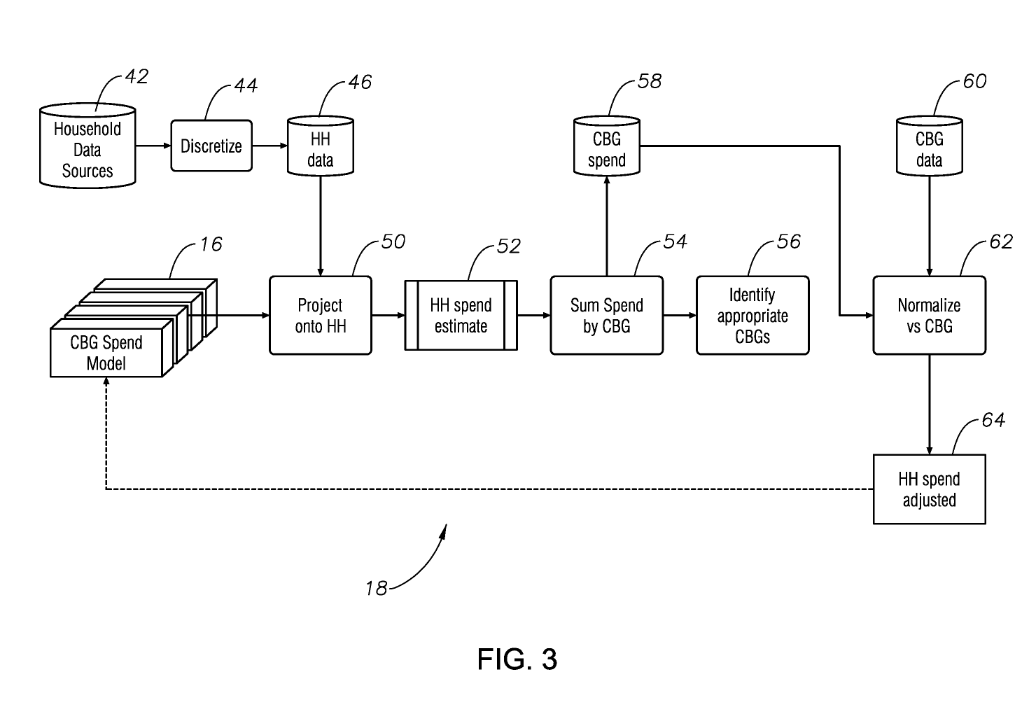

Referring to FIG. 3, actual household spend data for each household in one or more CBG subgroups is available and can be obtained from various sources 42. This specific information for each household in all or a selection subset of CBG regions (neighborhoods) is first discretized and binned in block 44 in the same manner as was done in block 20 of FIG. 2 for the household characteristic information, to obtain household data in block 46 having the same format as used to generate the CBG spend model from block 16. The CBG spend model 16 is then used to compute a household dollar spend number provided however that the household data in block 46 must provide data for each of the parameters required by the CBG spend model from block 16. This integration or projecting of the household parameters data (block 46) into the CBG spend model from block 16 is done in block 50.

For predicting the spend for each home in America, the preferred process goes through the following steps:

### Step 1—Prediction of Spend at the Household Level

Run the CBG subgroup spend model 16 for all homes in each CBG subgroup to produce a predicted (estimated) dollar spend number for each household in the one or more CBG subgroups. See block 52.

Sum the predicted values for each household in each CBG subgroup in block 54 to obtain a total predicted spend for all households in the CBG spend block 58.

Compare the resultant sum for each CBG subgroup (neighborhood) to the actual spend for that same CBG subgroup. The actual spend for each CBG subgroup can be obtained from available sources such as census data (block 60).

### Step 2—Normalize Spend Values

To increase accuracy, the dollar spend values are normalized in block 62. For example, if the actual spend for bottled water for the CBG subgroup (neighborhood) obtained from census data in block 60 was $100,000 and the sum of predicted dollar spend from block 52 for each household in the neighborhood was $90,000 from block 58, all CBG household values would be adjusted (normalized) in block 62 by a factor of 100,000/90,000 so that the sum, of the normalized spend would be the same as the spend from the census value from block 60. In this example, all actual household spend values for bottled water in the CBG subgroup would be increased by a factor of 100,000/90,000. Thus, in this example, the sum of the predicted dollar spend after being increased by the factor of 100,000/90,000 would be 8100.000. exactly matching the 8100.000 of bottled water spend from the census data (block 60).

### Step 3—Re-Model

The process described in steps 1 and 2 above can be repeated for each household in the US so that a dollar spend amount can be assigned to each household in one or more CBG subgroup or even the entire US. However, each of the households will have associated demographic attributes that were not included to obtain the CBG spend model in the modeling block 18 (FIGS. 1 and 3) because the attribute was not available at the CBG-level. Examples might include “household member has high cholesterol” or “household owns a second home.” These attributes can nevertheless be used to refine and improve the modeling. To use these attributes to refine the model for each household, the predicted dollar spend from block 64 for each household is treated as the actual spend and the modeling process 18 of FIGS. 1 and 3 is repeated using that dollar spend information instead of the CBG data from block 34.

The modeling process 36 is then performed for households rather than CBG subgroups (neighborhoods). The result is a much-expanded set of attributes with which to work, providing a more powerful model and accurate model. The adjusted models are made for each segment, using machine learning as before with neural networks, random forests and clusters.

The resulting final spend numbers from block 64 for each household are then used as an input to the model generator block 36 to generate a new CBG spend model with Steps 1 and 2 above being repeated with the new CBG spend model to generate a new adjusted household spend at block 64 as shown in FIG. 3. It should also be noted that the household spend block 64 uses machining learning in the same manner as describe above with respect to the model generator 36 in FIG. 2.

Often, census spend values are available for CBG subgroups (neighborhoods) at a group or subgroup level. For example, both total insurance dollar spend category values as well as the subcategories of life insurance, umbrella insurance, auto insurance and homeowners insurance may be available. Having these multiple values presents an option for additional refinements of the spend predictions by household. For example, for each CBG, the, total household spend for the category—total insurance dollar spend—is, compared with the total spend for each sub-category. In theory, the summation of spend for each sub-category of insurance should equal the total insurance dollar spend for the main category. However, if the figures do not match, the normalization process described above can be applied. For example, if the total insurance category spend for a specific CBG subgroup was $150,000 and the total summation of each subcategory of spend predictions at the household levels for the CBG subgroup was $100,000, each of the household spend predicted values would be increased by multiplying by a factor of $150,000/$100,000.

It will be appreciated from the foregoing that the present invention represents a significant advance over other systems and methods for targeted communications and advertising. More specifically, the system and method of the invention could use individual, household or company data or data from any other source or in any alternative category. In other embodiment, certain features described above such as normalization could be performed in other ways or omitted altogether depending on the application. Further, the present invention is not limited as to where the computations occur nor that the occur in one place or at the same time. In yet another embodiment, data could be gathered from multiple sources and then aggregated, or the invention could be separated into multiple sub-components to provide individualized household predictions with different algorithms applied to each household based upon either prior, current, or updated individualized household expenditure data. It will therefore be appreciated that, although a limited number of embodiments of the invention have been described in detail for purposes of illustration, various modifications may be made without departing from the spirit and scope of the invention. Accordingly, the invention should not be limited except as by the appended claims.

1. A method for predicting the amount of consumer spending on products and categories of products comprising the steps of:
a. Receiving consumer block group household information for consumer household characteristics from at least one consumer data;
b. Receiving actual individual household spend data from at least one household data source;
c. Segregating the consumer block group household information into consumer block subgroups where each consumer block subgroup has consumer household characteristics which are the same;
d. Generating at least one consumer block subgroup spend model for each consumer block subgroup by applying one or more machine learning algorithms to the consumer block subgroup information, the consumer block, subgroup spend model being a function of at least one selected household data characteristic;
e. Generating dollar spend values from the consumer block subgroup spend model;
f. Normalizing the generated dollar spend values so the generated dollar spend values for each consumer block subgroup is equal to actual consumer block spend amounts from the household data sources; and
g. Subjecting the normalize dollar spend values to one or more machine learning algorithms to generate adjusted household dollar spend values.
